(19) United States
(12) Patent Application Publication
(10) Pub. No.: US 2007/0196156 A1
(43) Pub. Date: Aug. 23, 2007

(54) Computer Keyboard and Mouse Security Shield

(76) Inventor: Jeremiah James Lewis, Bronxville, NY (US)

Correspondence Address: BROWN & MICHAELS, PC;400 M & T BANK BUILDING, 118 NORTH TIOGA ST, ITHACA, NY, 14850, US

(21) Appl. No.: 11/428,915

(22) Filed: Jul. 6, 2006

Related U.S. Application Data
(60) Provisional application No. 60/775,448, filed on Feb. 22, 2006.

(51) Int. Cl. B41J 29/02

(52) U.S. Cl. 400/691

(57) ABSTRACT

A security shield for a computer keyboard and mouse that prevents an unauthorized user from accessing the computer in the absence of the authorized user. The security shield consists of a rigid protective cover that is hingedly connected on one side to a base plate. A “U” shaped hasp is located at the other end of the protective cover to permit the installation of a conventional combination or keyed lock in order to lock the protective cover over the keyboard and mouse when the computer is not in use by the authorized user.

### REFERENCE TO RELATED APPLICATIONS

This application claims an invention which was disclosed in Provisional Application No. 60/775,448, filed Feb. 22, 2006, entitled “Computer Keyboard and Mouse Security Shield”. The benefit under 35 USC § 119(e) of the United States provisional application is hereby claimed, and the aforementioned application is hereby incorporated herein by reference.

### BACKGROUND OF THE INVENTION

1. Field of the Invention

The invention pertains to the field of security shields for electronic devices. More particularly, the invention pertains to a locking protective cover for a computer mouse and keyboard.

2. Description of Related Art

With the exponential growth of desktop computers in the business world and in homes, there is a need to provide a device to prevent the unauthorized use of the computer if the authorized user has left the workstation With the almost universal use of passwords, unauthorized access to a computer can be denied but this not is guaranteed because, for instance, the authorized user could have selected an obvious or otherwise weak password or the password was stolen or inadvertently disclosed. The use of password cracking software also could allow access to a computer by an unauthorized user.

Furthermore, it is often desirable or even necessary for the user to leave the computer on, even overnight, for example, to allow the computer to perform various time consuming functions, such as system backups, that would interfere with the user's productivity were such functions to be performed during regular business hours. In a crowded workplace, with many people present, the authorized user may simply want to prevent an unauthorized user from accessing his or her computer in the event that he or she steps away from the workstation for even a brief period of time.

Also, when the authorized user is away from the office or away from home on vacation or otherwise and the computer is shut down, the computer still could be accessed, even if password protected, as noted above, by an unauthorized user (e.g., colleagues, household guests or help). The unauthorized use of his or her computer could result in the disclosure of business or personal information, which could, in turn, result in financial or competitive losses to the business, identity theft or the introduction of computer viruses or objectionable websites or other undesirable events.

Various devices have been designed for the purpose of preventing unauthorized access to the mouse and keyboard of a desktop computer. For example, U.S. Pat. No. 6,571,948, issued Jun. 3, 2003 discloses a lock box for securely enclosing a computer keyboard and other operation components, such as a mouse. The box may have a removable top portion and provides for an integral lock. This design is complex in that, because of the rear hinge arrangement, the keyboard and mouse wires would have to be manipulated through holes or slots in the back portion of the base of the lock box so as to avoid contact with the hinges. Furthermore, with an integral lock, if the key is lost or an employee leaves or is terminated on un-amicable terms, taking the only key(s) with him or her, the security of that specific computer is compromised. This would require the replacement of the entire lock box, which adds an unforeseen, or at the very least, an unacceptable expense to the operation of the business.

The present invention overcomes these and other limitations of computer keyboard security shields and provides a simple, relatively inexpensive and highly effective apparatus for insuring that the security of each computer is not compromised by tampering from an unauthorized user.

### SUMMARY OF THE INVENTION

The present invention is a desktop computer keyboard and mouse security shield that consists of a generally rectangular base plate that is large enough to comfortably contain a keyboard and its accompanying mouse. A protective cover, having integral side walls of a height sufficient to prevent the protective cover from contacting keyboard and the mouse when in use, is hingedly connected to one side of the base plate either to the left or the right of the keyboard. The hinge(s) may permanently secure the base plate to the protective cover or they may be designed to be easily unhinged during removal of the protective cover to permit the temporary storage of the protective cover elsewhere until needed to secure the keyboard.

On the end of the security shield opposite from the hinge(s) is located the locking mechanism. The locking device consists of a “U” shaped hasp that may be securely mounted to either the base plate or the protective cover. If the hasp is installed on the base plate, then a slotted opening is provided on the top of the protective cover to permit the hasp to protrude therethrough when the protective cover is closed over the keyboard and mouse. If the hasp is securely mounted to the end side wall of the protective cover, the base plate will have an integral hinged side wall with a slot so that, when the protective cover is closed, the hinged side wall can be pivoted to meet the protective cover permitting the hasp to protrude through the slotted opening. Once the protective cover is installed over the keyboard and mouse and the “U” shaped hasp protrudes through the slotted opening, a locking device can be inserted through the hasp to securely lock the protective cover on the base plate. The locking device can be any simple keyed or combination padlock.

The protective cover and base plate can be made from any rigid material, such as plastic, wood or various metals. Plastic is preferred because of its design and manufacturing flexibility

### BRIEF DESCRIPTION OF THE DRAWING

FIG. 1 shows a frontal plan view of one embodiment of the security shield of the invention.

FIG. 2 shows a rear plan view of the embodiment of FIG. 1.

FIG. 3 shows a top plan view of the embodiment of FIG. 1 and FIG. 2.

FIG. 4 shows a second embodiment of the invention with the security shield partially open.

FIG. 5 shows a side plan view of the first embodiment of the invention.

FIG. 6 shows a side plan view of the second embodiment of the invention.

### DETAILED DESCRIPTION OF THE INVENTION

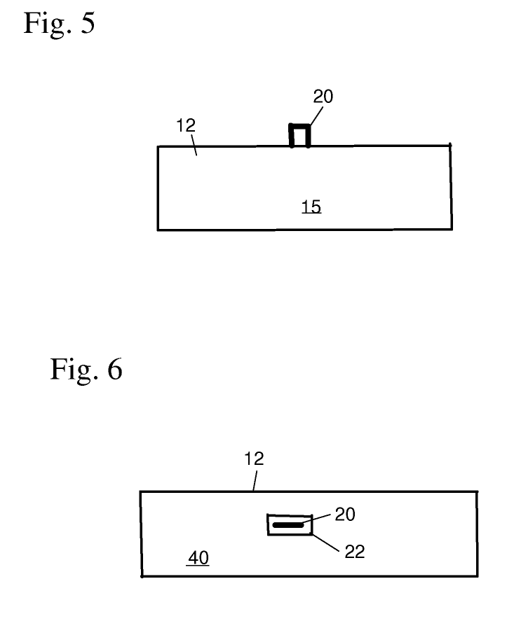

Referring to FIGS. 1 through 6, the security shield 10 of the present invention consists of a rectangular shaped protective cover 12 having sides of sufficient height to cover a conventional computer keyboard 30 and mouse 36. The front wall 14, rear wall 16, first side wall 13 and second side wall 15 are integral with and formed substantially 90 degrees from the top surface 17. The walls provide the structure to support the protective cover 12 of the security shield 10. Their height can be varied as needed to accommodate any size computer keyboard and mouse. The height of the walls is generally in the range of 2.5 to 3.5 inches.

The planar base plate 11 lies underneath the keyboard 30 and mouse 36 and is designed to correspond to the size of the top surface 17 so that when the security shield 10 is closed, the side walls of the protective cover 12 align with the perimeter of the base plate 11.

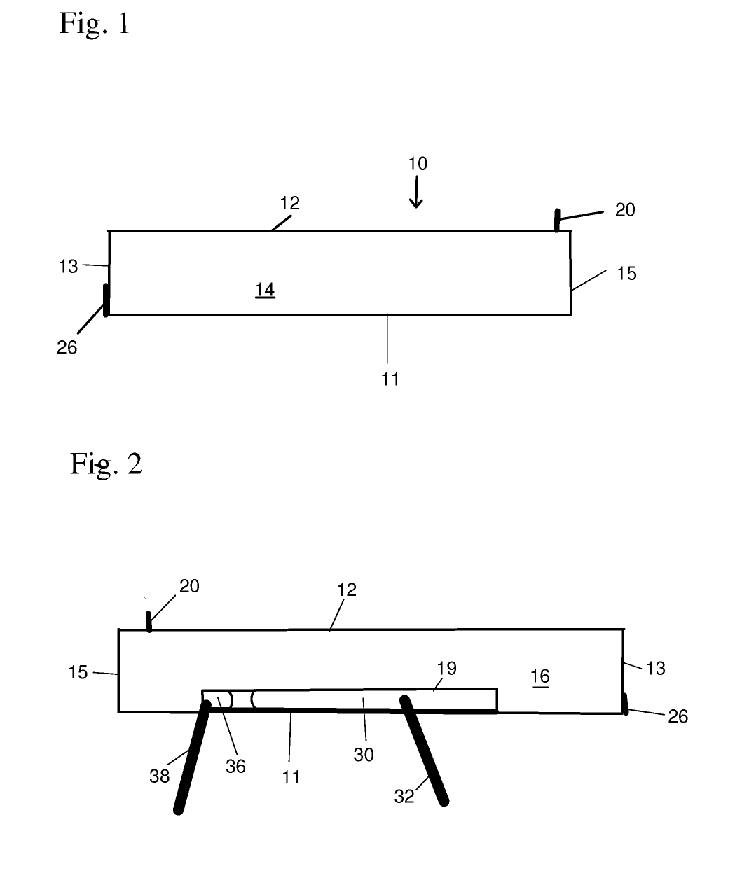

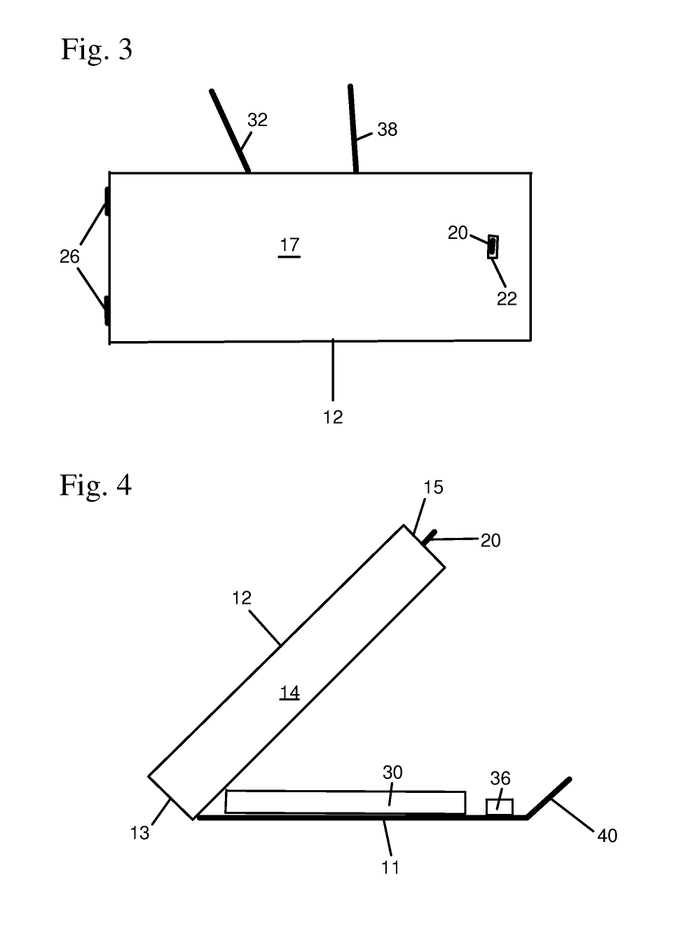

As shown in FIGS. 2 and 3, the rear wall 16 of the protective cover 12 has an opening 19 to permit the cable 32 from the keyboard 30 and the cable 38 from the mouse 36 to remain hooked up to the computer. The length of the opening 19 can be optimized for any keyboard and mouse design. For example, the opening may need to extend much of the length of rear wall 16 if the keyboard cable 32 is located at the far left side of the keyboard and the mouse is located to the right of the keyboard. A smaller opening is acceptable if the keyboard cable 32 is located at the right side of the keyboard with the mouse also being located on the right side of the keyboard.

At least one hinge 26 is located on the first side wall 13 and allows the protective cover 12 to pivot with respect to a first side edge of base plate 11. Preferably, two hinges are used so as to provide a more uniform pivoting motion. The hinges 26 may be located on the outside of the first side wall 13 or they may be located on the inner surface of the side wall. The hinges 26 may be permanently secured to both the base plate 11 and the protective cover 12 or they may be designed to be detachable. In the latter case, the part of the hinges permanently secured to the base plate 11 may consist of a rigid flat material that has a slot cut into it for interlocking with an elongated “L” shaped member that is permanently affixed to the first side wall 13. In operation, the base plate can remain under the keyboard 30 and mouse 36 while the protective cover 12 is removed to a location out of the way of the user's workstation. Alternatively, if the hinges 26 are permanently secured to both the protective cover 12 and the base plate 11, then the entire security shield 10 is removed to another location when the user is accessing the computer.

The locking mechanism for the security shield consists of a “U” shaped hasp 20 fitted through a slot 22. In the embodiment shown in FIGS. 1, 2, 3 and 5, the hasp 20 is permanently secured to the base plate 11 by any conventional means. The hasp 20 may be long enough to be secured directly to the base plate 11 or it may be secured to a segment perpendicularly upset from and integral with the base plate 11. The end of the hasp 20 must be long enough to fit through slot 22 located in the top surface 17 and receive an external locking device, such as a portable combination or keyed lock.

In the second embodiment, as shown in FIGS. 4 and 6, the hasp 20 extends outwardly from the surface of the second side wall 15. An integral side wall 40 is hingedly secured to the second side edge of the base plate 11 and contains a slot 22 through which the hasp 20 is inserted when the security shield is closed around the keyboard and mouse. The hasp 20 may be either rigidly secured to either the base plate 11 or the integral side wall 40, depending on the embodiment, or alternatively, the hasp 20 may be hinged at its base in order to provide ease of alignment with the corresponding slot 22.

The security shield 10 is made from any rigid material that must be capable of discouraging destructive incursion attempts. Materials such as steel, aluminum, or alloys thereof, wood and plastic may be used. It is preferable to utilize plastic as it may be easily molded to fit any size keyboard and mouse. The plastic may be reinforced with resins or fiberglass to provide added strength. Plexiglas is a desired material. Plastic materials also provide excellent strength without exhibiting the weight of metal alloys, thus permitting ease of use by any computer user.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A security shield for a computer keyboard and mouse comprising:
a) a substantially rectangular base plate having a first side edge and a second side edge and being of a size sufficient to contain the keyboard and mouse;
b) a substantially rectangular protective cover having a top surface of a size corresponding to the size of the base plate, the protective cover having a front wall, a rear wall, a first end wall and a second end wall, each wall being integral with and angled approximately ninety degrees from the plane of the top surface and having a height sufficient to enclose the keyboard and mouse without permitting contact of the top surface of the protective cover with the keyboard and mouse;
c) at least one hinge means to allow the first end wall to pivot with respect to the first side edge of the base plate;
d) a locking means in proximity to the second side wall of the protective cover and the second side edge of the base plate to permit an external locking device to securely lock the protective cover to the base plate.

2. The security shield of claim 1 wherein the locking means is a hasp.

3. The security shield of claim 2 wherein the hasp is secured to the base plate and protrudes through a slot in the top surface of the protective cover.

4. The security shield of claim 3 wherein the hasp is rigidly secured to the base plate.

5. The security shield of claim 3 wherein the hasp is hingedly secured to the base plate.

6. The security shield of claim 2 wherein the hasp is secured to the second end wall of the protective cover and protrudes through a slot in a side wall that is hingedly connected to the second edge of the base plate.

7. The security shield of claim 6 wherein the hasp is rigidly secured to the second wall of the protective cover.

8. The security shield of claim 6 wherein the hasp is hingedly secured to the second wall of the protective cover.

9. The security shield of claim 2 wherein the hasp receives an external locking device.

10. The security shield of claim 9 wherein the external locking device is a combination lock.

11. The security shield of claim 9 wherein the external locking device is a keyed lock.

12. The security shield of claim 1 consisting of a rigid material.

13. The security shield of claim 12 wherein the rigid material is plastic.
